(19) United States
(12) Patent Application Publication
(10) Pub. No.: US 2009/0116673 A1
(43) Pub. Date: May 7, 2009

(54) HEARING AID, IN PARTICULAR A BEHIND-THE-EAR HEARING AID, AND A METHOD OF ASSEMBLING A HEARING AID

(75) Inventors: Markus Heerlein, Singapore (SG); Thomas Kasztelan, Berlin (DE); Harald Klemenz, Singapore (SG); Daniel Reisse, Erlangen (DE)

Correspondence Address: LERNER GREENBERG STEMER LLP, P O BOX 2480, HOLLYWOOD, FL, 33022-2480, US

(73) Assignee: Siemens Medical Instruments PTE. Ltd., Singapore (SG)

(21) Appl. No.: 12/264,988

(22) Filed: Nov. 5, 2008

(30) Foreign Application Priority Data
Nov. 5, 2007 (DE) 10 2007 052 648.4

(51) Int. Cl. H04R 25/00; H04R 31/00

(52) U.S. Cl. 381/330; 29/896.21

(57) ABSTRACT

A hearing aid, in particular a behind-the-ear hearing aid, has a speaker for generating a sound signal, a connecting piece for emitting the sound signal, and a flexible sound tube for transporting the sound signal from the speaker to the connecting piece. The flexible sound tube is flexible at least in a longitudinal center section in a direction orthogonally to longitudinal direction. A method of assembling a hearing aid has the following steps: a longitudinal end of a flexible sound tube is fitted on/in a connecting piece or a speaker of the hearing aid; the flexible sound tube is bent toward the speaker or the connecting piece; and the second longitudinal end of the flexible sound tube is fitted on/in the speaker or on the connecting piece.

### CROSS-REFERENCE TO RELATED APPLICATION

This application claims the priority, under 35 U.S.C. § 119, of German application DE 10 2007 052 648.4, filed Nov. 5, 2007; the prior application is herewith incorporated by reference in its entirety.

### BACKGROUND OF THE INVENTION

### Field of the Invention

The invention relates to a hearing aid, in particular a behind-the-ear hearing aid having a speaker and a connecting piece. The invention also relates to a method for assembling and assembling a hearing aid, in particular a behind-the-ear hearing aid.

Adaptation of hearing aids to different hearing damage by means of different power levels, and to differing customer requirements, as well as the customer requirement for small and very small sizes is forcing the hearing aid manufacturers to produce a wide range of hearing aids with a different functional scope for different power levels. This is leading to a multiplicity of hearing aids of different sizes which are individually adaptable to hearing damage and customer requirements.

In general, hearing aids have a housing in which a microphone, an amplifier device, a speaker and a power supply, generally a zinc-air battery, are arranged. The speaker is connected to an acoustic output of the housing in order to emit the acoustic signals which are processed and produced by the hearing aid.

Hearing aids which can be worn behind the ear (referred to for short in the following text as behind-the-ear hearing aids) are normally held behind-the-ear of a hearing aid wearer by means of a supporting hook. In addition to holding the behind-the-ear hearing aid, the supporting hook generally also carries out another function. A sound line passes through the supporting hook, through which the sound which is produced by the speaker of the behind-the-ear hearing aid is transported to a flexible sound tube, which is connected to the front end of the supporting hook, and is passed on through this into an auditory channel of the hearing aid wearer, by means of a molded earpiece.

In one embodiment of a behind-the-ear hearing aid such as this, the supporting hook comprises a small curved titanium tube which is extrusion coated in places with a plastic material. This small titanium tube is guided from an attachment point on the speaker within the behind-the-ear hearing aid to the front end of the supporting hook, continuously. In order to mount the small titanium tube in the housing of the behind-the-ear hearing aid, this tube has, in an area between the actual housing of the behind-the-ear hearing aid and the supporting hook, a holding lug composed of plastic, by means of which the small titanium tube is fixed to/in the behind-the-ear hearing aid.

A hearing aid such as this may have a slimline form in the transitional area between the housing of the behind-the-ear hearing aid and the supporting hook, but the housing of the hearing aid must always be opened for replacement of the supporting hook. Furthermore, it is not feasible to produce a screw connection between the supporting hook and the housing of the behind-the-ear hearing aid.

In addition, behind-the-ear hearing aids are known which have a metal connecting piece for a supporting hook and which have a thread on a front section which projects on the housing of the behind-the-ear hearing aid. The supporting hook can be screwed onto the thread, thus allowing the supporting hook to be replaced easily in the event of repair. The connecting piece has an integral sound line, which opens into the speaker of the hearing aid.

Housing forms which are as small and slimline as possible are preferable for behind-the-ear hearing aids by adaptation of the behind-the-ear hearing aids to different hearing damage, for example on the basis of different power levels, as well as for cosmetic reasons and in order to increase the convenience of wearing them. This leads to the curvatures varying in an area on which the supporting hook can be provided, in different behind-the-ear hearing aids. Different metal connecting pieces are therefore required for different behind-the-ear hearing aids since there is a defined angle, which depends on the respective curvature within a specific behind-the-ear hearing aid, between a connecting area for the supporting hook and the sound line of the metal connecting piece.

German published patent application DE 10 2006 004 033 A1 describes a behind-the-ear hearing aid, in particular a micro-size, high-end hearing aid, having a molded earpiece which can be inserted into an inner ear. In this case, the behind-the-ear hearing aid is acoustically connected to the molded earpiece by means of a flexible sound tube and a flexible sound tube attachment element of the molded earpiece. In this case, the flexible sound tube is connected to the behind-the-ear hearing aid in such a way that it can be replaced quickly and easily.

### SUMMARY OF THE INVENTION

It is accordingly an object of the invention to provide a hearing aid and a assembling method which overcome the above-mentioned disadvantages of the heretofore-known devices and methods of this general type and which provides a better hearing aid, in particular a better behind-the-ear hearing aid, and a better assembling method for a hearing aid, to be precise a behind-the-ear hearing aid. In particular, one object of the invention is to provide a hearing aid and a assembling method for a hearing aid, in which case it is possible to pass sound on within the hearing aid with only a single, standardized connecting piece for a hearing aid with various housing forms.

One particular object of the invention is to be able to take account of different housing curvatures; that is to say the object is to be able to bridge different curvatures of the housing of the hearing aid by way of a standardized connecting piece. The object according to the invention preferably for a behind-the-ear hearing aid with a supporting hook which can be attached detachably, is to provide a slimline shape in a transitional area between a supporting hook and the actual housing of the behind-the-ear hearing aid.

With the foregoing and other objects in view there is provided, in accordance with the invention, a hearing aid (e.g., a behind-the-ear hearing aid), comprising:

a speaker for producing a sound signal;

a connecting piece for outputting the sound signal; and

a flexible sound tube connected between the speaker and the connecting piece for transporting the sound signal from the speaker to the connecting piece;

the flexible sound tube according to the invention being flexible at least in a longitudinal center section thereof and in a direction perpendicular to a longitudinal direction thereof.

According to the invention, the metal connecting piece, which is formed integrally with regard to the material in the prior art, is split into a two-part connecting piece. In this case, this results in a standardized connecting piece, which is identical for all or for a multiplicity of hearing aids in a single range or in a plurality of ranges, and a bridging connecting piece which can transport a sound signal from the speaker connected thereto to the actual standardized connecting piece. In this case, the bridging connecting piece is preferably in the form of a sound tube which is flexible at least in a longitudinal center section; that is to say the longitudinal center section of the flexible sound tube is designed to be flexible in a direction at right angles to its longitudinal direction.

According to the invention, the sound signal which is produced by the speaker of the hearing aid is transported via the flexible sound tube, which is flexible at least in the longitudinal center section, to the standardized connecting piece, wherein the connecting piece is firmly connected to a housing of the hearing aid. A supporting hook can be detachably attached to this connecting piece.

With the above and other objects in view there is provided, in accordance with the invention, a method for assembling a hearing aid, in particular a behind-the-ear hearing aid, which comprises the following steps:

providing a speaker, a connecting piece, and a flexible sound tube with first and second longitudinal ends;

fitting the first longitudinal end of the flexible sound tube to the connecting piece or the speaker of the hearing aid;

bending the flexible sound tube towards the speaker or the connecting piece; and

fitting the second longitudinal end of the flexible sound tube to the speaker or the connecting piece, i.e., to the opposite side.

In other words, the method according to the invention for the (initial) fitting of a hearing aid is carried out in such a way that a longitudinal end section of the flexible sound tube is first of all fitted to the connecting piece or to the speaker of the hearing aid. The longitudinal end section which is opposite the first longitudinal end section of the flexible sound tube is then attached to the speaker and/or to the connecting piece, in which case it is possible for the speaker and/or the connecting piece to have already been fitted in the housing of the hearing aid. Depending on whether no, one or both components (speaker, connecting piece) have already been fitted in the hearing aid, the flexible sound tube in the assembling method according to the invention is appropriately curved or bent.

The provision of the two-part connecting piece according to the invention, and/or the provision of the connecting piece according to the invention and of the flexible sound tube according to the invention, which is flexible in a direction at right angles to its longitudinal direction, allows there to be a different angle between an installed position of the connecting piece and an installed position of the speaker within the hearing aid. Identical connecting pieces and flexible sound tubes, which are essentially also identical, can thus be used for different hearing aids. The length of the flexible sound tube can be adapted, if necessary.

The invention avoids an expensive and complex production process for manufacturing metal connecting pieces with an integral, angled sound line, and the need to stock a multiplicity of metal connecting pieces thereof with different angles between a connecting section for the supporting hook and the sound line. According to the invention, only one design of the connecting piece is now produced, and the different angle for different hearing aids is compensated for or bridged by the flexible connecting tube.

In preferred embodiments of the invention, the flexible sound tube is designed to be flexible over its entire extent in a longitudinal direction, in particular in a direction at right angles to its longitudinal direction. This allows the flexible sound tube to be bent continuously at right angles in one direction along its entire longitudinal extent. That is to say the flexible sound tube is then held without kinks within the hearing aid, thus allowing the sound signal to be transported well from the speaker to the connecting piece, with as few losses and as little reflection as possible.

In preferred embodiments of the invention, the flexible sound tube can be deformed elastically in such a way that this elastic deformation capability makes it possible to bridge the angle between the installed position of the connecting piece and the installed position of the speaker. Furthermore, this can also be achieved by the flexible tube having the capability to be deformed plastically. In this case, it is particularly preferable for it to be possible to reverse this plastic deformation capability again, in such a manner that the flexible sound tube can be returned to its original position and its original configuration. This means that, in embodiments of the invention such as this, the flexible sound tube can be plastically deformed as reversibly as possible.

In all the embodiments of the invention, it is preferable for the flexible sound tube to retain essentially the same cross section, essentially in all cross sections, when bridging the distance between the speaker and the connecting piece, that is to say in its bent position, with respect to an unbent position. This relates in particular to the inner, preferably circular, cross sections of the flexible sound tube through which the sound signal passes.

In embodiments of the invention, the flexible sound tube has a mesh, preferably a wire mesh, which gives the flexible sound tube a certain amount of (cross-sectional) robustness. In particular, this makes it possible to influence the flexibility of the flexible sound tube. If the mesh is plastically deformed, then the flexible sound tube is preferably also plastically deformed. An analogous situation applies to elastic deformation of the mesh.

At least the front section of the connecting piece according to the invention, which preferably has a screw connection for the supporting hook, is produced from a metal or a metal alloy. The entire connecting piece according to the invention is preferably formed from metal or a metal alloy. This provides the necessary robustness on the hearing aid for the supporting hook.

The flexible sound tube according to the invention between the connecting piece according to the invention and the speaker of the hearing aid is preferably produced from a plastic. During production of the hearing aid and during (initial) assembling of the hearing aid, it is preferable for it to be possible to bend the flexible sound tube at any desired angle, such that it can therefore be used universally in any hearing aid. The flexible plastic sound tube is simply plugged onto/into the connecting piece and is thus fixed, and is then bent as appropriate for the angle with respect to the speaker, and is likewise fixed there. This can, of course, be kinematically reversed; that is to say the flexible plastic sound tube can first of all be plugged onto/into the speaker and thus fixed, only after which is it then attached to the connecting piece.

The flexible sound tube can be fitted to/in the connecting piece or to/in the speaker in each case via a plug connection and/or an adhesively bonded connection. In this case, it is possible to plug the flexible sound tube onto a projection on the connecting piece and/or onto a projection on the speaker; the opposite configuration is, of course, possible, with the flexible sound tube being inserted into a recess in the connecting piece and/or a recess in the speaker. A mixed form of attachments is, of course, likewise possible.

The splitting according to the invention of a single metal connecting piece—which on the one hand produces the screw connection for the supporting hook and on the other hand produces the acoustic connection to the speaker—into a flexible plastic tube, which can be attached to the speaker, and a metal connecting piece, to which the remaining free end of the flexible plastic sound tube is attached, can be produced more cheaply overall. This is a result in particular of the use of the flexible plastic sound tube since, in comparison to the metal line, this on the one hand is easier to produce and on the other hand allows simpler processing.

The metal connecting piece, which is formed integrally with respect to the material, in the prior art, can bridge only a single angle between the installed position of the metal connecting piece and the installed position of the speaker. According to the invention, the use of the flexible plastic sound tube means that this angle is not restricted to a single angle and, instead, the flexible plastic sound tube according to the invention can be used in a corresponding manner to bridge a plurality of angles, that is to say desired angles can be coped with according to the invention without problems. In consequence, only a standardized connecting piece and the flexible plastic sound tube, both of which can be used in all hearing aids are required for all hearing aids of one type or one range. The only adaptation that is generally now required is to the length of the flexible plastic sound tube.

Other features which are considered as characteristic for the invention are set forth in the appended claims.

Although the invention is illustrated and described herein as embodied in hearing aid, in particular a behind-the-ear hearing aid, and a corresponding assembly method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF SEVERAL VIEWS OF THE DRAWINGS

FIG. 1 shows a partially open side view of an assembly of a supporting hook on a behind-the-ear hearing aid according to the prior art;

FIG. 2 is side view of a metal connecting piece according to the prior art, for a hearing aid;

FIG. 3 shows a partially sectioned side view of a configuration according to the invention for transporting a sound signal from a speaker in the hearing aid to a connecting piece, according to the invention, of the hearing aid;

FIG. 4 shows a sectioned side view of a mechanical connection according to the invention of a flexible sound tube according to the invention to the speaker and/or the connecting piece of the configuration from FIG. 3; and

FIG. 5 shows an alternative mechanical connection according to the invention, relating to FIG. 4.

### DETAILED DESCRIPTION OF THE DRAWING

The invention will be explained in more detail in the following text with reference to a hearing aid which is worn behind the ear, referred to in the following text as a behind-the-ear hearing aid. However, the invention is not restricted to behind-the-ear hearing aids such as these but is applicable in an entirely general form to devices to assist hearing; that is to say it also relates to devices which are not only used to improve a hearing weakness but which are also suitable for improving the hearing capability of a wearer of a device for assisting hearing in an acoustically difficult situation—for example on a building site. This relates, for example, to hearing protection with an integrated radio.

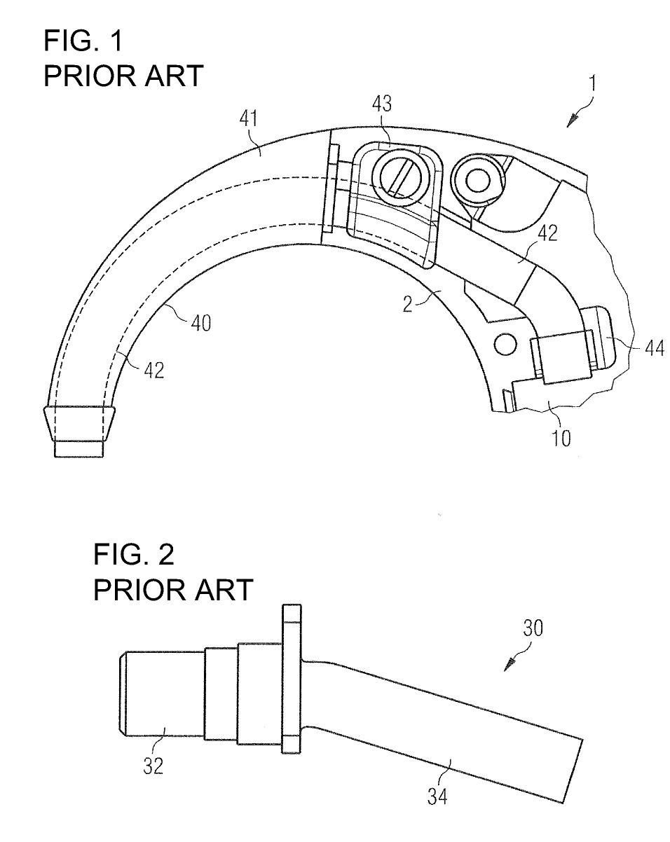

Referring now to the figures of the drawing in detail and first, particularly, to FIG. 1 thereof, there is shown a side view of an upper subarea of a housing 2 of a behind-the-ear hearing aid 1 according to the prior art. The upper subarea of the housing 2 merges continuously into a supporting hook 40, which comprises a small titanium tube 42 and plastic extrusion coating 41.

In order to attach the supporting hook 40 and/or the small titanium tube 42, the small titanium tube 42 has a connecting lug 43, which is likewise produced by plastic extrusion coating of the small titanium tube 42. Furthermore, at a rear end facing away from the supporting hook 40, the small titanium tube 42 is mounted by means of a holding element 44 in the housing 2 of the behind-the-ear hearing aid 1.

An embodiment such as this of a behind-the-ear hearing aid 1 according to the prior art has the disadvantage that the small titanium tube 42 cannot be provided with an attachment section, for example a thread, by means of which the behind-the-ear hearing aid 1 and the supporting hook 40 can easily be connected to one another. It is therefore not possible to create a detachable connection for the supporting hook 40 in the transitional area to the housing 2 of the behind-the-ear hearing aid 1. The housing 2 of the behind-the-ear hearing aid 1 must be opened in order to replace the supporting hook 40. Furthermore, the small titanium tube 42 passes completely through the supporting hook 40 in an embodiment such as this, thus preventing a transparent embodiment of the supporting hook 40.

FIG. 2 shows a solution according to the prior art in which a detachable attachment of a supporting hook to an upper area of a housing of a behind-the-ear hearing aid is provided (this is not all illustrated in FIG. 2). The supporting hook is in this case attached to a connecting piece 30 which is composed of a metal or a metal alloy and can be fitted in the upper area of the housing of the behind-the-ear hearing aid.

The metal connecting piece 30 is provided on its front section, which projects out of the behind-the-ear hearing aid, with an external thread 32 onto which the supporting hook can be screwed. In this case, the supporting hook 40 is not fitted as shown in FIG. 1, and has an internal thread which corresponds to the external thread 32 on the connecting piece 30.

Furthermore, the metal connecting piece 30 has a sound line 34 which is formed integrally, with regard to the material, with that section of the connecting piece which projects out of the behind-the-ear hearing aid. In this case, the sound line 34 is provided with a certain angle with respect to the rest of the metal connecting piece 30. This angle is matched to the curvature of a relevant area of the behind-the-ear hearing aid. A free end of the sound line 34 is acoustically connected to a speaker of the behind-the-ear hearing aid.

One particular disadvantage in this case is that, depending on the behind-the-ear hearing aid, different curvatures exist in the relevant area of the behind-the-ear hearing aid for the metal connecting piece 30, which means that the metal connecting piece 30 must be individually matched to the relevant behind-the-ear hearing aid from a range.

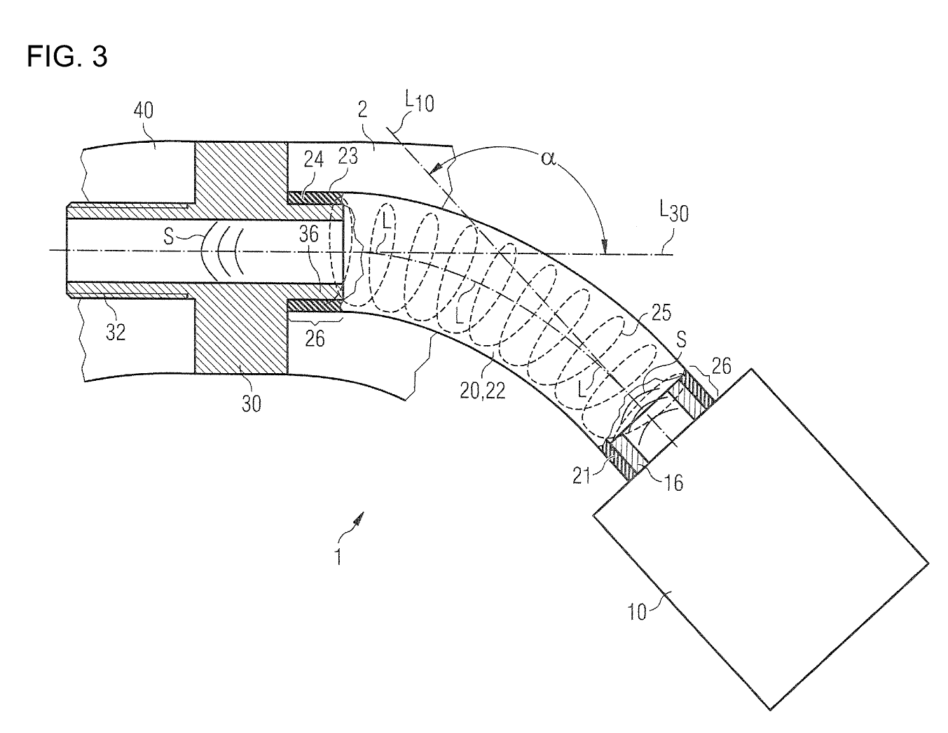

FIG. 3 shows a configuration according to the invention of a speaker 10 and of a connecting piece 30, which are acoustically coupled to one another via a flexible sound tube 20 according to the invention. In this case, the speaker 10 is arranged within a housing 2 of a behind-the-ear hearing aid 1 according to the invention, and the connecting piece 30, together with a section which is provided outside the housing 2, forms a mechanical connection for a supporting hook 40, which can be screwed onto a thread 32 on the section or the connecting piece 30.

According to the invention, the flexible sound tube 20 can be connected to the speaker 10 and/or to the connecting piece 30. In this case, it is possible for the flexible sound tube 20 to be in the form of a separate part—that is to say separate from the speaker 10 and the connecting piece 30—or for the flexible sound tube 20 to be provided or to be formed with the speaker 10 and/or the connecting piece 30. Sound signals S which are generated by the speaker 10 can be transported by means of the flexible sound tube 20 from the speaker 10 to the connecting piece 30, and from there into the supporting hook 40.

According to the invention, the flexible sound tube 20 is designed such that it can bridge different configurations of speaker 10 and connecting piece 30. This means that—apart from the length of the flexible sound tube 20—this is intended to be designed in such a way that it can acoustically couple connecting piece/speaker configurations 30/10 which are positioned differently with respect to one another.

This is illustrated by the variable angle α shown in FIG. 3, which denotes the angle α between the longitudinal ends 21, 23, or the longitudinal end sections 21, 23, of the flexible sound tube 20. When the flexible sound tube 20 is in the installed position, this then also corresponds to the angle α between a longitudinal center line L₁₀ of the speaker 10 and a longitudinal center line L₃₀ of the connecting piece 30.

According to the invention, the flexible sound tube 20 is designed to be flexible at least in a longitudinal center section 22. This relates in particular to a direction at right angles to its longitudinal direction L. In this case, an acoustic connection is preferably produced between the speaker 10 and the connecting piece 30 as follows: first of all, a longitudinal end section 21, 23 of the flexible sound tube 20 is fitted to the connecting piece 30 or to the speaker 10. This can be done, for example, directly after production of the connecting piece 30 or directly after assembling of the speaker 10. However, it is also possible for this not to be done until the behind-the-ear hearing aid 1 is being assembled. The flexible sound tube 20 is then fitted to the speaker 10 and/or to the connecting piece 30 by bending the flexible sound tube 20 appropriately toward the speaker 10 or the connecting piece 30, and then attaching it thereto.

According to the invention, it is possible to first of all fit the speaker 10 and the connecting piece 30 within the behind-the-ear hearing aid 1 and then to attach the flexible sound tube 20 to/in the relevant part (speaker 10, connecting piece 30). However, it is also possible to first of all connect the speaker 10 via the flexible sound tube 20 to the connecting piece 30, and then to fit this jointly in the behind-the-ear hearing aid 1. Partial assembling, that is to say assembling of the speaker 10 or of the connecting piece 30 in the behind-the-ear hearing aid 1 first of all, followed by assembling of the flexible sound tube 20 to the connecting piece 30 or to the speaker 10, which is or can be provided thereon, is, of course, possible.

In preferred embodiments of the invention, the entire flexible sound tube 20, or its longitudinal center section 22, can be bent continuously, as a result of which the fitted flexible sound tube 20 or its longitudinal center section 22 is guided within the behind-the-ear hearing aid 1 without kinking. In this case, the entire flexible sound tube 20 or its longitudinal center section 22 is preferably bent continuously within the behind-the-ear hearing aid 1 and has a curved profile—preferably apart from one or both assembling sections 26 of the flexible sound tube 20 on the speaker 10 or the connecting piece 30. This means that, preferably apart from the assembling section or sections 26, the flexible sound tube 20 does not have a linear profile when fitted in the behind-the-ear hearing aid 1.

According to the invention, the flexible sound tube 20, to be precise its longitudinal center section 22 is elastically and/or plastically deformable in the area between the assembling sections 26. This relates in particular to the direction at right angles to the longitudinal direction L of the flexible sound tube 20. In this case, the flexible sound tube 20 is preferably configured such that it essentially retains at least an inner, acoustic cross section when bent.

In preferred embodiments of the invention, the flexible sound tube 20, to be precise its longitudinal center section 22, is plastically deformable. In this case, the flexible sound tube 20, to be precise its longitudinal center section 22, is designed such that, when bent plastically, at least the internal cross section of the flexible sound tube 20 is essentially maintained and as little elastic reverse deformation as possible takes place.

In preferred embodiments of the invention, the flexible sound tube 20, to be precise its longitudinal center section 22, has a stiffening element 25 on or in its wall 24, which provides the flexible sound tube 20 with robustness and bendability. A stiffening element 25 such as this in this case extends at least in places in the longitudinal direction L on/within the wall 24.

In preferred embodiments of the invention, the stiffening element 25 is in the form of a mesh 25 within the flexible sound tube 20, in particular in the form of a wire mesh 25. According to the invention, in this case, the mesh 25 is elastically and/or plastically deformable when the flexible sound tube 20 is bent. The mesh 25 is preferably also plastically deformable when the flexible sound tube 20 is bent or is deformed only slightly, as a result of which the mesh 25 provides the flexible sound tube 20 with its plastic deformation capability. Furthermore, the mesh 25 is preferably suitable for essentially maintaining the internal cross section of the flexible sound tube 20 when the latter is bent.

The flexible sound tube 20 can be firmly connected by means of a plug and/or adhesively bonded connection to the connecting piece 30 and/or to the speaker 10. In this case, it is possible to plug the flexible sound tube 20 onto a relevant connecting section 16, 36 of the speaker 10 or of the connecting piece 30 and—if necessary, to adhesively bond it thereto. However, it is also possible to omit a connecting piece 16, 36 such as this and to plug the relevant assembling section 26 of the flexible sound tube 20 into the speaker 10 or into the connecting piece 30, and to mount it there in an appropriate manner.

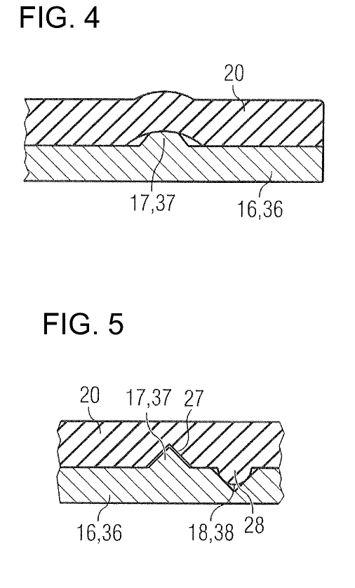

FIGS. 4 and 5 show developments of an attachment of the flexible sound tube 20 to the speaker 10 and/or to the connecting piece 30. In this case, the speaker 10 and/or the connecting piece 30 have at least one projection 17, 37 which additionally holds or fixes the flexible sound tube 20. In this case, the respective projection 17, 37 is preferably completely circumferential.

According to the invention, this has the advantage that the flexible sound tube 20 can be firmly connected to the speaker 10 and to the connecting piece 30 without any need to use adhesive. A further advantage is that, in contrast to attachment by means of adhesive, wider manufacturing tolerances are possible for the production of the flexible sound tube 20 and of the corresponding connecting section 16, 36. Another advantage is that the flexible sound tube 20 can easily be detached from the speaker 10 and from the connecting piece 30, for cleaning.

FIG. 4 shows an embodiment with at least one preferably externally circumferential projection 17, 37 on the relevant connecting section 16, 36. The flexible sound tube 20 is pushed in over this projection 17, 37 when it is fitted to the speaker 10 and to the connecting piece 30, respectively. Contrary to the illustration in FIG. 4, a plurality of such projections 17, 37 can be provided according to the invention.

FIG. 5 shows a further embodiment of an attachment according to the invention of the flexible sound tube 20 to the speaker 10 or to the connecting piece 30. In this case, a projection 17, 37 on the corresponding connecting section 16, 36 engages in a recess 27 in the flexible sound tube 20. This recess 27 is designed to correspond to the relevant projection 17, 37.

In the present exemplary embodiment, the recess 27 is in the form of a groove which has a triangular cross section and is preferably completely circumferential internally on the flexible sound tube 20. In a corresponding manner to this, the projection 17, 37 is designed as a projection 17, 37 which is externally circumferential on the relevant connecting section 16, 36 and likewise has a triangular cross section. This can, of course, be designed in the opposite manner, and the statement is likewise intended to apply to other embodiments of the invention.

Furthermore, FIG. 5 shows a projection 28 which is formed internally on the flexible sound tube 20 and is preferably likewise provided completely circumferentially. In this case, the projection 28 has a rounded form. This projection 28 engages in a preferably completely circumferential recess 18, 38 in the speaker 10 or the connecting piece 30, which recess 18, 38 in the illustrated exemplary embodiment is in the form of a groove with a triangular cross section.

The embodiments shown in FIGS. 4 and 5 can be combined with one another as required, and can be used for many purposes. For example, in particular, it is possible to provide a plurality of projections 17, 37 on the relevant connecting section 16, 36. Furthermore, a multiplicity of different cross sections of the corresponding projection 17, 37; 28 and of the corresponding recess 27; 18, 38 are possible. In this case, as illustrated on the right in FIG. 5, it is not absolutely essential to provide mutually corresponding profiles for the projection 17, 37; 28 and the recess 27; 18, 38. All that is necessary is to ensure that a certain clamping effect (FIG. 4) or an interlocking and/or force-assembling connection (i.e., positive and/or friction lock), is produced between the flexible sound tube 20 and the corresponding connecting section 16, 36.

Furthermore, it is possible to interchange the configuration of one or both assembling sections 26, of the flexible sound tube 20 with the corresponding connecting section 16, 26; that is to say to provide the relevant assembling section 26 within the relevant connecting section 16, 26. In this case, the embodiments of the invention as shown in FIGS. 4 and 5 can then be used in a kinematically reversed form.

1. A hearing aid, comprising:
a speaker for producing a sound signal;
a connecting piece for outputting the sound signal; and
a flexible sound tube connected between said speaker and said connecting piece for transporting the sound signal between said speaker and said connecting piece;
said flexible sound tube being flexible at least in a longitudinal center section thereof and in a direction perpendicular to a longitudinal direction thereof.

2. The hearing aid according to claim 1, wherein said flexible sound tube is continuously bendable along a longitudinal center section thereof.

3. The hearing aid according to claim 1, wherein said flexible sound tube is configured to have no kinks along a longitudinal center section thereof when fitted within the hearing aid.

4. The hearing aid according to claim 1, wherein said flexible sound tube is configured to be curved continuously along a longitudinal center section thereof when fitted within the hearing aid.

5. The hearing aid according to claim 1, wherein said flexible sound tube, when fitted within the hearing aid, has a curved profile substantially over an entire longitudinal extent thereof, apart from a assembling section.

6. The hearing aid according to claim 1, wherein said flexible sound tube is plastically deformable along a longitudinal center section thereof.

7. The hearing aid according to claim 6, wherein said flexible sound tube is reversibly plastically deformable.

8. The hearing aid according to claim 1, wherein said flexible sound tube is elastically deformable along a longitudinal center section thereof.

9. The hearing aid according to claim 1, which comprises a stiffening element disposed on or in a wall of a longitudinal center section of said flexible sound tube, said stiffening element providing said flexible sound tube with robustness and bendability.

10. The hearing aid according to claim 9, wherein said stiffening element is a wire mesh.

11. The hearing aid according to claim 9, wherein said stiffening element is a mesh configured to be elastically and/or plastically deformable when said flexible sound tube is bent.

12. The hearing aid according to claim 1, wherein said flexible sound tube is produced substantially from a plastic and said connecting piece is produced substantially from a metal or a metal alloy.

13. The hearing aid according to claim 1, wherein said flexible sound tube is formed with two longitudinal ends or end sections and a flexible longitudinal center section, and wherein said ends or end sections are bent over said center section by an angle of between about 180° and about 0°.

14. The hearing aid according to claim 13, wherein the angle lies between 180±30° and 90±20°.

15. The hearing aid according to claim 13, wherein the angle lies between 180±20° and 135±10°.

16. The hearing aid according to claim 13, wherein the angle lies between 180±10° and 150±10°.

17. The hearing aid according to claim 13, wherein the angle lies between 180±5° and 165±5°.

18. The hearing aid according to claim 1, wherein said flexible sound tube is adhesively bonded to at least one of said connecting piece and said speaker.

19. The hearing aid according to claim 1, wherein said flexible sound tube is connected to at least one of said connecting piece and said speaker by way of a plug connection.

20. The hearing aid according to claim 1, wherein the hearing aid has only a single flexible sound tube.

21. The hearing aid according to claim 1, configured as a behind-the-ear hearing aid.

22. A method for assembling a hearing aid, which comprises the following steps:
providing a speaker, a connecting piece, and a flexible sound tube with first and second longitudinal ends;
fitting the first longitudinal end of the flexible sound tube to the connecting piece or the speaker of the hearing aid;
bending the flexible sound tube towards the speaker or the connecting piece; and
fitting the second longitudinal end of the flexible sound tube to the speaker or the connecting piece.

23. The assembling method according to claim 22, which comprises forming a behind-the-ear hearing aid.

24. The assembling method according to claim 22, which comprises, before or after the fitting of the flexible sound tube, mounting the speaker and/or the connecting piece in a housing of the hearing aid.

25. The assembling method according to claim 22, which comprises forming the hearing aid according to claim 1.
